(19) United States
(12) Patent Application Publication
(10) Pub. No.: US 2026/0188682 A1
(43) Pub. Date: Jul. 2, 2026

(54) BINDER FOR SECONDARY BATTERY AND SECONDARY BATTERY INCLUDING THE SAME

(71) Applicants: SK ON CO., LTD., Seoul (KR); Industry-Academic Cooperation Foundation, Yonsei University, Seoul (KR)

(72) Inventors: Ju Sung HAN, Daejeon (KR); Myung Soo PARK, Daejeon (KR); Gun Young KIM, Daejeon (KR); Jeong Hun KIM, Seoul (KR); Hee Ji JEON, Seoul (KR); Min Seok JEONG, Seoul (KR); Seong Hyeon JUNG, Seoul (KR)

(21) Appl. No.: 19/433,071

(22) Filed: Dec. 26, 2025

(30) Foreign Application Priority Data
Dec. 27, 2024 (KR) 10-2024-0199234

(51) Int. Cl. H01M 4/62; C09J 141/00; H01M 10/052

(52) U.S. Cl. CPC H01M 4/622; C09J 141/00; H01M 10/052

(57) ABSTRACT

A binder for a secondary battery according to embodiments of the present disclosure includes a conductive polymer doped with a dopant. The dopant is a copolymer including a first repeating unit including a sulfonate group and a second repeating unit including at least one of a carboxyl group, a sulfonic acid group, or a phosphonic acid group. According to embodiments of the present disclosure, a secondary battery including the above-described binder may be provided.

### CROSS-REFERENCE TO RELATED APPLICATION

This application claims priority to Korean Patent Application No. 10-2024-0199234 filed on Dec. 27, 2024 in the Ministry Of Intellectual Property (MOIP), the entire disclosure of which is incorporated by reference herein.

### BACKGROUND

### 1. Field of the Invention

The present disclosure relates to a cathode binder for a secondary battery, a cathode including the binder, and a secondary battery including the cathode.

### 2. Description of the Related Art

Secondary batteries are batteries that can be repeatedly charged and discharged, and are being widely applied as a power source for portable electronic communication devices such as camcorders, mobile phones, notebook PCs, and the like, in accordance with the development of the information communication and display industries. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery has been actively developed and applied due to its high operating voltage, high energy density per unit weight, and advantages in charging speed and weight reduction.

The lithium secondary battery may include an electrode assembly including, for example, a cathode, an anode and a separator interposed between the cathode and the anode, and an electrolyte that impregnates the electrode assembly.

An electrode of the lithium secondary battery may include an electrode current collector and an electrode active material layer formed on the electrode current collector. For example, the electrode active material layer may include an electrode active material, a conductive material, a binder, and the like.

Meanwhile, among polymers used as a binder, PVdF has poor bonding strength, which may cause partial detachment during the drying process, and its adhesive strength tends to decrease with repeated charge and discharge cycles.

Therefore, research has been conducted to synthesize an electrode binder having excellent adhesive strength and high electrical conductivity to solve the above-described problems.

### SUMMARY

An object of the present disclosure is to provide a binder for a secondary battery with improved stability and enhanced mobility of electrolyte ions.

Another object of the present disclosure is to provide an electrode for a secondary battery and a secondary battery having improved stability and high energy density.

A binder for a secondary battery according to the present disclosure includes a conductive polymer doped with a dopant, wherein the dopant is a copolymer including a first repeating unit including a sulfonate group; and a second repeating unit including at least one of a carboxyl group, a sulfonic acid group, or a phosphonic acid group.

According to exemplary embodiments, the molar ratio of the second repeating unit to the first repeating unit may be 1/5 to 1.

According to exemplary embodiments, the molar ratio of the second repeating unit to the first repeating unit may be 1/3 to 1.

According to exemplary embodiments, the conductive polymer may include at least one selected from the group consisting of a polythiophene-based polymer, a polyaniline-based polymer, a polystyrene-based polymer, a polypyrrole-based polymer, a polyacetylene-based polymer, a polyazine-based polymer, a polyphenylene-based polymer, and a polyselenophene-based polymer.

According to exemplary embodiments, the conductive polymer may include a polythiophene-based polymer.

According to exemplary embodiments, the first repeating unit may include a repeating unit represented by Chemical Formula 1 below:

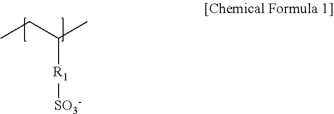

In Chemical Formula 1, R₁ is an aromatic hydrocarbon group.

According to exemplary embodiments, in Chemical Formula 1, R₁ may be an aromatic hydrocarbon group having 6 to 12 carbon atoms.

According to exemplary embodiments, in Chemical Formula 1, R₁ may be a substituted or unsubstituted aryl group having 6 to 12 carbon atoms.

According to exemplary embodiments, the substituted aryl group of R₁ in Chemical Formula 1 may be an aryl group substituted with a halogen, an alkyl group having 1 to 5 carbon atoms, or an alkoxy group having 1 to 5 carbon atoms.

According to exemplary embodiments, in Chemical Formula 1, R₁ may be a phenylene group.

According to exemplary embodiments, the second repeating unit may include a repeating unit represented by Chemical Formula 2 below:

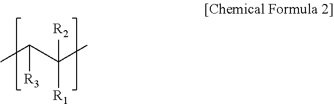

In Chemical Formula 2, R₁ is a carboxyl group, a sulfonic acid group, or a phosphonic acid group, R₂ is hydrogen or an alkyl group having 1 to 5 carbon atoms, and R₃ is hydrogen or a carboxyl group.

According to exemplary embodiments, a weight-average molecular weight of the dopant may be 50 kDa to 900 kDa.

According to exemplary embodiments, a weight-average molecular weight of the dopant may be 100 kDa to 500 kDa.

According to exemplary embodiments, a weight ratio of the conductive polymer to the dopant may be 1:0.1 to 1:10.

According to exemplary embodiments, a weight ratio of the conductive polymer to the dopant may be 1:0.5 to 1:2.

A slurry for a secondary battery electrode according to the present disclosure may include the binder for a secondary battery.

According to exemplary embodiments, the slurry may further include an organic binder or an aqueous binder different from the binder for a secondary battery.

According to exemplary embodiments, the organic binder may be selected from the group consisting of a vinylidene fluoride-hexafluoropropylene copolymer (PVDF-co-HFP), polyvinylidene fluoride (PVDF), polyacrylonitrile, polyacrylamide, and polymethylmethacrylate.

According to exemplary embodiments, an electrode manufactured with the slurry for a secondary battery electrode is provided.

According to exemplary embodiments, a secondary battery is provided, which includes: a cathode manufactured with the slurry for a secondary battery electrode; an anode; and a separator interposed between the cathode and the anode.

The binder according to exemplary embodiments of the present disclosure may include a dopant having a specific substituent group, thereby exhibiting improved adhesive strength. Accordingly, the bonding strength between an active material and a current collector may be enhanced, and the stability of a battery may be improved.

The binder according to exemplary embodiments of the present disclosure may exhibit improved conductivity, thereby enhancing the mobility of electrolyte ions. Accordingly, the amount of the conductive material may be minimized and the amount of cathode active material may be increased, thereby improving the energy density of the battery.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 and FIG. 2 are schematic plan view and cross-sectional view, respectively, illustrating a secondary battery according to exemplary embodiments.

### DETAILED DESCRIPTION

Hereinafter, embodiments of the present invention will be described in detail with reference to the drawings. However, the embodiments are merely illustrative, and the present disclosure is not limited to the specific embodiments described as examples.

According to embodiments of the present invention, a binder for a secondary battery including a conductive polymer doped with a dopant is provided. By including the binder according to embodiments of the present invention, the electrical conductivity of an electrode may be improved, and the energy density of the battery may be increased by reducing the content of the conductive material and increasing the content of the electrode active material.

In an embodiment, the conductive polymer may include at least one selected from the group consisting of a polythiophene-based polymer, a polyaniline-based polymer, a polystyrene-based polymer, a polypyrrole-based polymer, a polyacetylene-based polymer, a polyazine-based polymer, a polyphenylene-based polymer, and a polyselenophene-based polymer.

In an embodiment, the conductive polymer may include a polythiophene-based polymer.

In an embodiment, the conductive polymer may be doped with a dopant. Doping the conductive polymer may refer to a process in which a salt is formed between the conductive polymer and dopant ions.

In exemplary embodiments, the dopant may be a copolymer including a first repeating unit including a sulfonate group (—SO₃⁻) and a second repeating unit including at least one of a carboxyl group (—COOH), a sulfonic acid group (—SO₃H), or a phosphonic acid group (—H₂PO₃). Doping the conductive polymer with the dopant may improve the adhesive properties of the binder. Accordingly, the bonding strength between the electrode active material and the current collector may be improved.

In an embodiment, the dopant may be an anionic dopant. The anionic dopant may be a copolymer including a first repeating unit and a second repeating unit.

In an embodiment, the first repeating unit may include a sulfonate group. Including the sulfonate group may provide an anion to enable doping through an ionic bond with the conductive polymer.

In an embodiment, the first repeating unit may include a repeating unit represented by Chemical Formula 1 below.

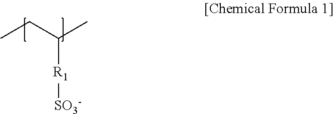

In Chemical Formula 1, R₁ is an aromatic hydrocarbon group.

In an embodiment, the aromatic hydrocarbon group may be a substituted or unsubstituted aryl group having 6 to 12 carbon atoms, and the substituted aryl group may be an aryl group substituted with a halogen, an alkyl group having 1 to 5 carbon atoms, or an alkoxy group having 1 to 5 carbon atoms.

In an embodiment, R₁ may be a phenylene group.

In an embodiment, the second repeating unit may include at least one of a carboxyl group, a sulfonic acid group, or a phosphonic acid group. Including the carboxyl group, the sulfonic acid group, or the phosphonic acid group may contribute to doping and further improve the mobility of electrolyte ions.

In an embodiment, the second repeating unit may include a repeating unit represented by Chemical Formula 2 below.

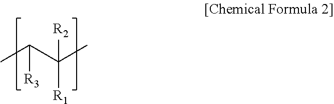

In Chemical Formula 2, R₁ may be a carboxyl group, a sulfonic acid group, or a phosphonic acid group, R₂ may be hydrogen or an alkyl group having 1 to 5 carbon atoms, and R₃ may be hydrogen or a carboxyl group.

In some embodiments, the molar ratio of the second repeating unit to the first repeating unit may be 1/5 to 1, for example, 1/3 to 1, for example, 1/2 to 1. Within the range of the molar ratio, the doping ability of the dopant for the conductive polymer may be improved.

In some embodiments, a weight-average molecular weight of the dopant may be 50 kDa to 900 kDa, for example, 50 kDa to 700 kDa, for example, 100 kDa to 600 kDa, for example, 100 kDa to 500 kDa. Within the range of the weight-average molecular weight, the doping ability of the dopant for the conductive polymer may be improved.

In some embodiments, a weight ratio of the conductive polymer to the dopant may be 1:0.1 to 1:10, for example, 1:0.2 to 1:8, for example, 1:0.5 to 1:5, for example, 1:0.5 to 1:2. Within this range, the dopant may be effectively doped into the conductive polymer.

In exemplary embodiments, the binder may further include an organic binder such as a vinylidene fluoride-hexafluoropropylene copolymer (PVDF-co-HFP), polyvinylidene fluoride (PVDF), polyacrylonitrile, polyacrylamide, polymethylmethacrylate, or an aqueous binder such as styrene-butadiene rubber (SBR), and may be used together with a thickener such as carboxymethyl cellulose (CMC).

The binder for a secondary battery may fix the cathode active material and/or the anode active material of the secondary battery. For example, the binder for a secondary battery may be mixed with the cathode active material or the anode active material to form a slurry, and the slurry may then be applied to a current collector to form a cathode or anode.

In an embodiment, the binder for a secondary battery may be used for a cathode using a lithium-transition metal oxide active material. The binder may strongly bond an active material layer including the lithium-transition metal oxide active material to a current collector, thereby improving the structural stability of the cathode.

In exemplary embodiments of the present disclosure, an electrode manufactured with the binder and a secondary battery including the electrode may be provided.

Hereinafter, the embodiments of the present disclosure will be described in more detail with reference to the accompanying drawings. However, the drawings attached to the present invention are merely illustrative of some embodiments of the present disclosure to aid in understanding the technical spirit of the present disclosure along with the foregoing description of the disclosure. Therefore, the present disclosure should not be construed as being limited to the matters illustrated in the drawings.

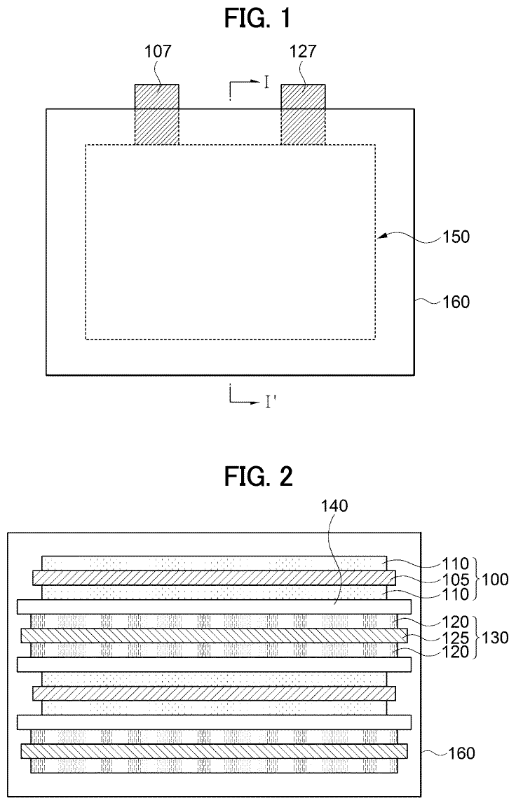

FIG. 1 and FIG. 2 are schematic plan view and cross-sectional view, respectively, illustrating a secondary battery according to exemplary embodiments. In this embodiment, a lithium secondary battery is described as an example.

Referring to FIG. 1 and FIG. 2, the secondary battery may include an electrode cell 150 including a cathode 100, an anode 130, and a separator 140 interposed between the cathode 100 and the anode 130. The electrode cell 150 may be impregnated with an electrolyte within a case 160.

The cathode 100 may include a cathode active material layer 110 formed on a cathode current collector 105 by applying a cathode active material thereto.

The cathode active material layer 110 may be formed on at least one surface of the cathode current collector 105. According to exemplary embodiments, the cathode active material layer 110 may be formed on one surface of the cathode current collector 105 and on an opposite surface facing the one surface.

The cathode active material may include a compound capable of reversibly intercalating and deintercalating lithium ions.

In exemplary embodiments, the cathode active material may include lithium (Li)-transition metal oxide particles. The lithium-transition metal oxide particles may further include at least one of cobalt (Co), manganese (Mn), and aluminum (Al). For example, the cathode active material may include a plurality of lithium-transition metal oxide particles.

In an embodiment, the cathode active material or the lithium-transition metal oxide particles may include a layered structure or a crystal structure represented by Chemical Formula 3 below.

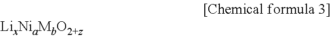

In Chemical Formula 3, x, a, b and z may satisfy 0.9≤x≤1.2, 0.6≤a≤0.99, 0.01≤b≤0.4, and −0.5≤z≤0.1. As described above, M may include Co, Mn and/or Al.

The chemical structure represented by Chemical Formula 3 indicates a bonding relationship among elements included in the layered structure or the crystal structure of the cathode active material or the lithium-transition metal oxide particles, and does not exclude the presence of additional elements. For example, M includes Co and/or Mn, and Co and/or Mn may be provided as main active elements of the cathode active material together with Ni. Chemical Formula 3 is provided to express the bonding relationship of the main active elements, and is a Chemical formula encompassing the introduction and substitution of additional elements.

In an embodiment, auxiliary elements for enhancing the chemical stability of the cathode active material or the layered structure/crystal structure may be further included in addition to the main active elements. The auxiliary elements may be incorporated into the layered structure/crystal structure together with the main active elements to form bonds, and his case should also be understood as being included within the scope of the chemical structure represented by Chemical Formula 3.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may serve as an auxiliary active element that contributes to the capacity/output activity of the cathode active material together with Co or Mn, such as, for example, Al.

In an embodiment, the lithium metal oxide may be a nickel-cobalt-manganese (NCM)-based lithium oxide. In this case, an NCM-based lithium oxide with an increased content of nickel may be used.

Nickel (Ni) may serve as a transition metal associated with the output and capacity of a lithium secondary battery. Therefore, as described above, by employing a high-nickel-content (high-Ni) composition in the cathode active material, a high-capacity cathode and a high-capacity lithium secondary battery may be provided.

However, as the Ni content increases, the long-term storage stability and cycle life stability of the cathode or the secondary battery may be relatively degraded, and side reactions with an electrolyte may also be increased. Nevertheless, according to exemplary embodiments, by including Co to maintain electrical conductivity, the cycle life stability and capacity retention properties may be improved through Mn.

The content of Ni (e.g., the molar fraction of nickel based on a total number of moles of nickel, cobalt and manganese) in the NCM-based lithium oxide may be 0.5 or more, 0.6 or more, 0.7 or more, or 0.8 or more, 0.9 or more, or 0.95 or more. In some embodiments, the content of Ni may be 0.8 to 0.98, 0.82 to 0.98, 0.83 to 0.98, 0.84 to 0.98, 0.85 to 0.98, or 0.88 to 0.98, or 0.9 to 0.98.

In some embodiments, the ratio of a total number of moles of nickel in the lithium-transition metal oxide particles to a total number of moles of metals other than lithium in the lithium-transition metal oxide particles may be 0.9 or more, and in an embodiment, 0.94 or more. Within this range, the output properties and capacity properties may be improved.

In an embodiment, the lithium-transition metal oxide may be represented by Chemical Formula 4 below.

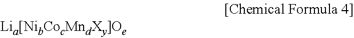

In Chemical Formula 4, X may include at least one of W, S, Al, Ti, Sr, Zr, P and K, and a, b, c, d, e and y may satisfy 0.5<a<1.5, 0.5≤b≤1, 0≤c<0.3, 0=d<0.3, 1.5<e<2.5, and 0≤y<0.1.

The cathode active material may be mixed and stirred with a binder, a conductive material, and/or a dispersant in a solvent to prepare a slurry. The slurry may be coated on the cathode current collector 105, and then compressed and dried to prepare the cathode 100.

The cathode current collector 105 may include, for example, stainless steel, nickel, aluminum, titanium, copper, or an alloy thereof, and may preferably include aluminum or an aluminum alloy.

In an embodiment, the binder according to an embodiment of the present disclosure may be used as a cathode binder. In this case, the amount of conductive material for forming the cathode active material layer 110 may decrease, and the amount of cathode active material may relatively increase. Accordingly, the output properties and capacity properties of the secondary battery may be improved.

The conductive material may be added to the cathode active material layer 110 to enhance the conductivity of the cathode active material layer (110) and/or the mobility of lithium ions or electrons. For example, the conductive material may further include a carbon-based conductive material such as graphite, carbon black (e.g., Denka Black), acetylene black, Ketjen Black, graphene, vapor-grown carbon fiber (VGCF), carbon nanotube (CNT), and carbon fiber, and/or a metal-based conductive material such as tin, tin oxide, titanium oxide; as well as perovskite materials such as LaSrCoO₃ and LaSrMnO₃. These may be used alone or in combination of two or more thereof.

The cathode slurry may further include a thickener and/or a dispersant. In an embodiment, the cathode slurry may include a thickener such as carboxymethyl cellulose (CMC).

The anode 130 may include an anode current collector 125 and an anode active material layer 120 formed on at least one surface of the anode current collector 125.

For example, the anode current collector 125 may include a copper foil, nickel foil, stainless steel foil, titanium foil, nickel foam, copper foam, or a polymer substrate coated with a conductive metal. These may be used alone or in combination of two or more thereof. For example, the anode current collector 125 may have a thickness of 10 μm to 50 μm.

The anode active material layer 120 may include an anode active material. As the anode active material, a material capable of adsorbing and desorbing lithium ions may be used. For example, as the anode active material, carbon-based materials such as crystalline carbon, amorphous carbon, carbon composites, or carbon fibers, etc.; lithium metal; a lithium alloy; a silicon (Si)-containing material or a tin (Sn)-containing material, etc. may also be used. These may be used alone or in combination of two or more thereof.

The amorphous carbon may include hard carbon, soft carbon, coke, mesocarbon microbead (MCMB), mesophase pitch-based carbon fiber (MPCF) or the like.

The crystalline carbon may include graphite-based carbon such as natural graphite, artificial graphite, graphitized coke, graphitized MCMB, graphitized MPCF or the like.

The lithium metal may include pure lithium metal and/or lithium metal on which a protective layer is formed for suppressing dendrite growth. In an embodiment, a lithium metal-containing layer deposited or coated on the anode current collector 125 may be used as the anode active material layer 120. In an embodiment, a lithium thin-film layer may also be used as the anode active material layer 120.

Elements contained in the lithium alloy may include aluminum, zinc, bismuth, cadmium, antimony, silicon, lead, tin, gallium, indium, etc. These may be used alone or in combination of two or more thereof.

The silicon-containing material may provide further increased capacity properties. The silicon-containing material may include Si, SiOₓ (0<x<2), metal-doped SiOₓ (0<x<2), a silicon-carbon composite, etc.

The metal may include lithium and/or magnesium, and the metal-doped SiOₓ (0<x<2) may include a metal silicate.

The anode active material may be mixed in a solvent to prepare an anode slurry. The anode slurry may be coated or deposited on the anode current collector 125, and then dried and roll-pressed to prepare the anode active material layer 120. The coating may include processes such as gravure coating, slot die coating, simultaneous multilayer die coating, imprinting, doctor blade coating, dip coating, bar coating or casting, or the like. The anode active material layer 120 may further include a binder, and optionally may further include a conductive material, a thickener or the like.

The solvent included in the anode slurry may include water, purified water, deionized water, distilled water, ethanol, isopropanol, methanol, acetone, n-propanol, t-butanol and the like. These may be used alone or in combination of two or more thereof.

As the binder, conductive material and thickener, the above-described materials that can be used in preparing the cathode 100 may be used.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder. These may be used alone or in combination of two or more thereof.

In exemplary embodiments, the separator 140 may be interposed between the cathode 100 and the anode 130. The separator 140 may be configured to prevent an electrical short-circuit between the cathode 100 and the anode 130, and to allow a flow of ions to occur. For example, the separator may have a thickness of 10 μm to 20 μm.

For example, the separator 140 may include a porous polymer film or a porous non-woven fabric.

The porous polymer film may include a polyolefin-based polymer such as an ethylene polymer, propylene polymer, ethylene/butene copolymer, ethylene/hexene copolymer, or ethylene/methacrylate copolymer, etc. These may be used alone or in combination of two or more thereof.

The porous non-woven fabric may include glass fibers having a high melting point, polyethylene terephthalate fibers, etc.

The separator 140 may also include a ceramic-based material. For example, inorganic particles may be coated on the polymer film or dispersed within the polymer film to improve heat resistance.

The separator 140 may have a single-layer or multilayer structure including the above-described polymer film and/or non-woven fabric.

According to exemplary embodiments, the electrode cell 150 may be defined by the cathode 100, the anode 130 and the separator 140, and a plurality of electrode cells may be stacked to form, for example, a jelly roll type electrode assembly. For example, the electrode assembly may be formed by winding, stacking, z-folding, or stack-folding the separator 140.

The electrode assembly may be accommodated in the case 160 together with the electrolyte to define a lithium secondary battery. According to exemplary embodiments, a non-aqueous electrolyte may be used as the electrolyte.

The non-aqueous electrolyte may include a lithium salt of an electrolyte and an organic solvent. For example, the lithium salt may be represented by Li⁺X⁻; and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)PF₂⁻, (CF₃)₅PF⁻, (CF₃)P⁻, CF₃SO₃⁻, CF₃CF₂SO₃⁻; (CF₃SO₂)₂N⁻, (FSO₂)₂N⁻; CF₃CF₂(CF₃)₂CO⁻, (CF₃SO₂)₂CH⁻, (SF₅)₃C⁻, (CF₃SO₂)₃C⁻, CF₃(CF₂)₇SO₃⁻; CF₃CO₂⁻, CH₃CO₂⁻, SCN⁻ and (CF₃CF₂SO₂)₂N⁻, etc. may be exemplified.

The organic solvent may include, for example, propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMIEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, γ-butyrolactone, propylene sulfite or the like. These may be used alone or in combination of two or more thereof.

The non-aqueous electrolyte may further include an additive. The additive may include, for example, a cyclic carbonate-based compound, a fluorine-substituted carbonate-based compound, a sultone-based compound, a cyclic sulfate-based compound, a cyclic sulfite-based compound, a phosphate-based compound, a borate-based compound or the like. These may be used alone or in combination of two or more thereof.

The cyclic carbonate-based compound may include vinylene carbonate (VC), vinyl ethylene carbonate (VEC), etc.

The fluorine-substituted carbonate-based compound may include fluoroethylene carbonate (FEC), etc.

The sultone-based compound may include 1,3-propane sultone, 1,3-propene sultone, 1,4-butane sultone, etc.

The cyclic sulfate-based compound may include 1,2-ethylene sulfate, 1,2-propylene sulfate, etc.

The cyclic sulfite-based compound may include ethylene sulfite, butylene sulfite, etc.

The phosphate-based compound may include lithium difluoro bis(oxalato)phosphate, lithium difluorophosphate, etc.

The borate-based compound may include lithium bis(oxalate)borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separator 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂-LiₚMO_{q} (p and q are positive numbers, M is P, Si, Ge, B, Al, Ga or In), Li₂-xPS₆-xClₓ (0≤x≤2), Li₂-xPS₆—XBrₓ (0≤x≤2), Li₂-xPS₆-xIₓ (0≤x≤2), etc. These may be used alone or in combination of two or more thereof.

In an embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 1 and 2, electrode tabs (a cathode tab and an anode tab) may respectively protrude from a cathode current collector 105 and an anode current collector 125 belonging to each electrode cell 1 and extend to one side of a case 160. The electrode tabs may be fused or welded together with the one side of the case 160 to form electrode leads (a cathode lead 107 and an anode lead 127) that extend or are exposed to the outside of the case 160.

The lithium secondary battery may be manufactured, for example, in a cylindrical, prismatic, pouch, or coin type using a can.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications may be made within the scope and spirit of the present disclosure, and such changes and modifications are to be regarded as falling within the scope of the appended claims.

### Example 1

### (1) Preparation of Dopant

A dopant copolymer was prepared according to Reaction Scheme 1 below.

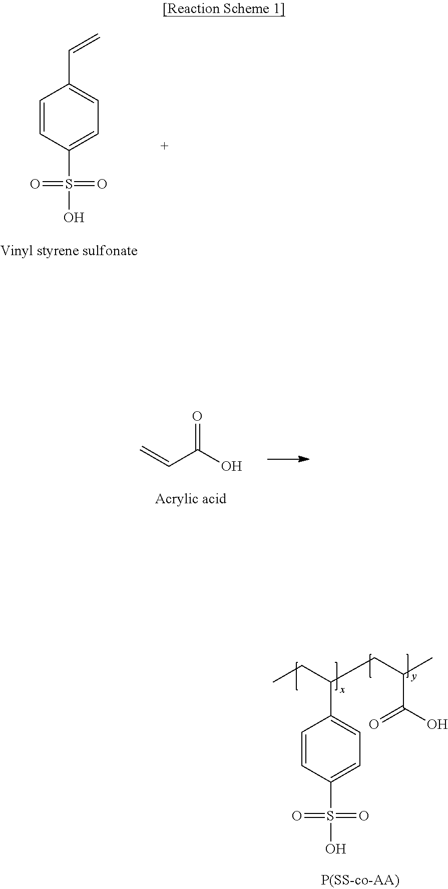

Vinyl styrene sulfonate and acrylic acid were added to and mixed in distilled water from which dissolved oxygen had been removed by bubbling N₂ for 1 hour to prepare a mixed solution. The mixed solution was introduced into a reactor at 80° C., and a co-precipitation reaction was performed for 12 hours using persulfate as an initiator to obtain P(SS-co-AA) (poly(styrene sulfonate-co-acrylic acid) copolymer). The reaction was performed under atmospheric pressure.

In this case, the molar ratio between the first repeating unit (styrene sulfonate) and the second repeating unit (acrylic acid), and the weight-average molecular weight of the prepared P(SS-co-AA) are shown in Table 1.

### (2) Preparation of Dopant-Doped Conductive Polymer Binder

A dopant-doped conductive polymer binder was prepared according to Reaction Scheme 2 below.

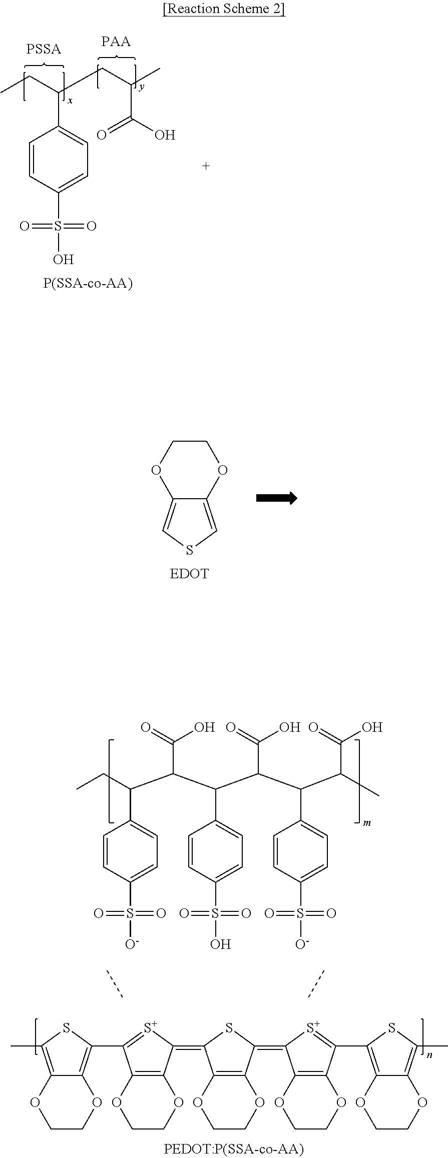

The P(SS-co-AA) and EDOT(3,4-ethylenedioxythiophene) were added to and mixed in distilled water from which dissolved oxygen had been removed by bubbling N₂ for 1 hour to prepare a mixed solution. The mixed solution was introduced into a reactor at 25° C., and a co-precipitation reaction was performed for 24 hours using persulfate as an initiator to obtain PEDOT:P(SS-co-AA) (poly(3,4-ethylenedioxythiophene) doped with poly(styrene sulfonate-co-acrylic acid)). The reaction was performed under atmospheric pressure.

The ratio between the dopant and conductive polymer is shown in Table 1.

### (3) Preparation of Lithium-Transition Metal Oxide Particles

NiSO₄, CoSO₄, and MnSO₄ were added to and mixed in distilled water from which dissolved oxygen had been removed by bubbling N₂ for 24 hours at a molar ratio of 94:5:1 to prepare a mixed solution. The mixed solution was introduced into a reactor at 50° C., and a co-precipitation reaction was performed for 72 hours using NaOH and NH₃·H₂O as a precipitant and a chelating agent, respectively, to obtain Ni_{0.94}Co_{0.05}Mn_{0.01}(OH)₂ as a transition metal precursor. The transition metal precursor was dried at 100° C. for 12 hours and then further dried at 120° C. for 10 hours.

Lithium hydroxide and the transition metal precursor were added to a dry high-speed mixer at a ratio of 1.03:1 and uniformly mixed for 20 minutes. The mixture was placed in a calcination furnace, heated to 850° C. at a heating rate of 2° C./min, and calcined at 850° C. for 12 hours. Oxygen was continuously supplied at a flow rate of 10 mL/min during the heating and calcination. After completion of the calcination, the product was naturally cooled to room temperature, and then pulverized and classified to obtain lithium-transition metal oxide particles (LiNi_{0.94}Co_{0.03}Mn_{0.03}O₂) in the form of single particles.

### (4) Preparation of Lithium Secondary Battery

A lithium secondary battery was manufactured using the lithium-transition metal oxide particles as a cathode active material.

Specifically, the cathode active material, Denka Black and CNT as conductive materials, and the binder were mixed at a mass ratio of 97.7:0.5:0.5:1.3 to prepare a cathode slurry. The cathode slurry was applied to an aluminum current collector, and then dried and roll-pressed to prepare a cathode.

An anode slurry was prepared, including 93% by weight (“wt %”) of natural graphite as an anode active material, 5 wt % of flake-type graphite (KS6) as a conductive material, 1 wt % of styrene-butadiene rubber (SBR) as a binder, and 1 wt % of carboxymethyl cellulose (CMC) as a thickener. The anode slurry was applied to a copper substrate, and then dried and roll-pressed to prepare an anode.

14 Sheets of cathode and 15 sheets of the anodes were notched into a predetermined size and stacked, then an electrode cell was prepared by interposing a separator (polyethylene, thickness: 25 μm) between the cathode and the anode. Thereafter, tab portions of the cathode and the anode were welded, respectively. The assembly of the welded cathode/separator/anode was placed into a pouch, and three sides of the pouch were sealed, leaving one side open for electrolyte injection. At this time, a portion having the electrode tab was included in the sealed part. After injecting an electrolyte through the electrolyte injection side, the remaining electrolyte injection side was also sealed, and the cell was left to be impregnated for 12 hours or more.

As the electrolyte, a solution was used, which was prepared by adding 1 wt % of vinylene carbonate (VC) and 0.5 wt % of 1,3-propanesultone (PRS), based on the total weight of the solution, to a 1 M LiPF₆ solution prepared using a mixed solvent of EC/EMC (25/75; volume ratio).

The manufactured lithium secondary battery was pre-charged at a current of 5 A corresponding to 0.25 C for 36 minutes. After 1 hour, degassing was performed, followed by aging for 24 hours or more, and then formation charging-discharging was carried out (charging conditions: CC-CV 0.2 C 4.2V 0.05 C cut-off, discharging conditions: CC 0.2 C 2.5 V cut-off).

### Examples 2 to 8 and Comparative Examples 1 to 2

Cathode binders and lithium secondary batteries were manufactured in the same manner as in Example 1, except that the types of the first and second repeating units, the molar ratio between the repeating units of the dopant, and the weight ratio of the dopant to the conductive polymer were changed, as shown in Table 1 below.

TABLE 1

| | | | | Weight ratio | Weight- |
|---|---|---|---|---|---|
| | | | Molar ratio | (dopant to | average |
| | | Type of | (first repeating | conductive | molecular |
| | Type of first | second | unit:second | polymer | weight of |
| | repeating unit | repeating unit | repeating unit) | (PEDOT)) | dopant (g/mol) |
| Example 1 | Styrene | Acrylic acid | 2:1 | 1:1 | 102,431 |
| | sulfonate | | | | |
| Example 2 | Styrene | Acrylic acid | 1:1 | 1:1 | 153,100 |
| | sulfonate | | | | |
| Example 3 | Styrene | Acrylic acid | 1:2 | 1:1 | 182,300 |
| | sulfonate | | | | |
| Example 4 | Styrene | Acrylic acid | 1:1 | 1:2 | 175,724 |
| | sulfonate | | | | |
| Example 5 | Styrene | Acrylic acid | 1:1 | 2:1 | 167,344 |
| | sulfonate | | | | |
| Example 6 | Styrene | Phosphonic | 1:1 | 1:1 | 127,711 |
| | sulfonate | acid | | | |
| Example 7 | Styrene | Phosphonic | 3:1 | 1:1 | 155,222 |
| | sulfonate | acid | | | |
| Example 8 | Styrene | Phosphonic | 5:1 | 1:1 | 139,248 |
| | sulfonate | acid | | | |
| Comparative | — | — | — | PEDOT only | — |
| Example 1 | | | | | |
| Comparative | Styrene | — | — | — | 110,492 |
| Example 2 | sulfonate | | | | |

### Experimental Examples

### (1) Evaluation of Electrical Conductivity

The electrical conductivity of the lithium secondary batteries manufactured in the above-described examples and comparative examples was measured using a powder resistance measuring device (MCP-PD51, Nittoseiko Analytech).

Specifically, 2 g of a cathode active material sample was pressurized to a density of approximately 2.0 g/cc, and the resistance and electrical conductivity of the sample were measured.

The analysis conditions are as follows.
Start lane: 1 Ω
Voltage limiter: 10 V
Probe: 4-pin probe (electrode distance: 3.0 mm/electrode radius: 0.7 mm/sample radius: 10.0 mm)

### (2) Evaluation of Adhesion

After attaching a tape to the electrode, the tape was removed at a constant speed and force using a universal testing machine (UTM). The force required to remove the tape from the electrode was quantified to determine the adhesive strength of each binder.

The electrical conductivity and adhesion measurement results for the lithium secondary batteries of the examples and comparative examples are shown in Table 2.

TABLE 2

| | Electrical conductivity (S/cm) | Adhesion |
|---|---|---|
| Example 1 | 440 | 4N |
| Example 2 | 380 | 3N |
| Example 3 | 250 | 4N |
| Example 4 | 260 | 3N |
| Example 5 | 450 | 3N |
| Example 6 | 45 | 3N |
| Example 7 | 48 | 2N |
| Example 8 | 108 | 2N |
| Comparative Example 1 | 0.1 | 0N |
| Comparative Example 2 | 0 | 0N |

Referring to Table 2, the examples exhibited improved electrical conductivity and adhesion as compared to the comparative examples. Accordingly, the electrochemical performance and stability of the battery were improved.

Furthermore, in the case of Example 1, which satisfies a molar ratio of the second repeating unit to the first repeating unit is 1/5 to 1, the overall battery performance was further improved as compared to Example 3, which does not satisfy such a ratio.

The contents described above are merely examples of applying the principles of the present disclosure, and other configurations may be further included without departing from the scope of the present disclosure.

What is claimed is:

1. A binder for a secondary battery, comprising a conductive polymer doped with a dopant,
wherein the dopant is a copolymer comprising a first repeating unit comprising a sulfonate group; and a second repeating unit comprising at least one of a carboxyl group, a sulfonic acid group, or a phosphonic acid group.

2. The binder for a secondary battery according to claim 1, wherein a molar ratio of the second repeating unit to the first repeating unit is 1/5 to 1.

3. The binder for a secondary battery according to claim 1, wherein a molar ratio of the second repeating unit to the first repeating unit is 1/3 to 1.

4. The binder for a secondary battery according to claim 1, wherein the conductive polymer comprises at least one selected from the group consisting of a polythiophene-based polymer, a polyaniline-based polymer, a polystyrene-based polymer, a polypyrrole-based polymer, a polyacetylene-based polymer, a polyazine-based polymer, a polyphenylene-based polymer, and a polyselenophene-based polymer.

5. The binder for a secondary battery according to claim 1, wherein the conductive polymer comprises a polythiophene-based polymer.

6. The binder for a secondary battery according to claim 1, wherein the first repeating unit comprises a repeating unit represented by Chemical Formula 1 below: 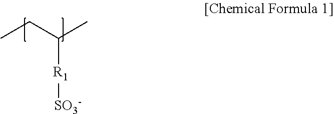
wherein, in Chemical Formula 1, R₁ is an aromatic hydrocarbon group.

7. The binder for a secondary battery according to claim 6, wherein in Chemical Formula 1, R₁ is an aromatic hydrocarbon group having 6 to 12 carbon atoms.

8. The binder for a secondary battery according to claim 7, wherein, in Chemical Formula 1, R₁ is a substituted or unsubstituted aryl group having 6 to 12 carbon atoms.

9. The binder for a secondary battery according to claim 8, wherein the substituted aryl group of R₁ in Chemical Formula 1 is an aryl group substituted with a halogen, an alkyl group having 1 to 5 carbon atoms, or an alkoxy group having 1 to 5 carbon atoms.

10. The binder for a secondary battery according to claim 6, wherein in Chemical Formula 1, R₁ is a phenylene group.

11. The binder for a secondary battery according to claim 1, wherein the second repeating unit comprises a repeating unit represented by Chemical Formula 2 below: 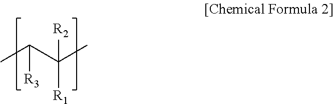
wherein, in Chemical Formula 2, R₁ is a carboxyl group, a sulfonic acid group, or a phosphonic acid group, R₂ is hydrogen or an alkyl group having 1 to 5 carbon atoms, and R₃ is hydrogen or a carboxyl group.

12. The binder for a secondary battery according to claim 1, wherein a weight-average molecular weight of the dopant is 50 kDa to 900 kDa.

13. The binder for a secondary battery according to claim 1, wherein a weight-average molecular weight of the dopant is 100 kDa to 500 kDa.

14. The binder for a secondary battery according to claim 1, wherein a weight ratio of the conductive polymer to the dopant is 1:0.1 to 1:10.

15. The binder for a secondary battery according to claim 1, wherein a weight ratio of the conductive polymer to the dopant is 1:0.5 to 1:2.

16. A slurry for a secondary battery electrode comprising the binder for a secondary battery according to claim 1.

17. The slurry for a secondary battery electrode according to claim 16, wherein the slurry further comprises an organic binder or an aqueous binder different from the binder for a secondary battery.

18. The slurry for a secondary battery electrode according to claim 17, wherein the organic binder is selected from the group consisting of a vinylidene fluoride-hexafluoropropylene copolymer (PVDF-co-HFP), polyvinylidene fluoride (PVDF), polyacrylonitrile, polyacrylamide, and polymethylmethacrylate.

19. An electrode manufactured with the slurry for a secondary battery electrode according to claim 16.

20. A secondary battery comprising:
a cathode manufactured with the slurry for a secondary battery electrode according to claim 16;
an anode; and
a separator interposed between the cathode and the anode.
